(19) United States
(12) Patent Application Publication
(10) Pub. No.: US 2006/0115243 A1
(43) Pub. Date: Jun. 1, 2006

(54) Resistance-heated boat and manufacturing method thereof

(76) Inventors: Jae-In Jeong, Kyongsangbuk-do (KR); Tae-Gyoon Lim, Kyongsangnam-do (KR)

Correspondence Address: COOPER & DUNHAM, LLP, 1185 AVENUE OF THE AMERICAS, NEW YORK, NY, 10036, US

(21) Appl. No.: 10/534,134

(22) PCT Filed: Dec. 1, 2003
(86) PCT No.: PCT/KR03/02620

§ 371 Date: May 6, 2005

(30) Foreign Application Priority Data
Dec. 23, 2002 (KR) 10-2002-0082792

(51) Int. Cl. B01D 7/00

(52) U.S. Cl. 392/388

(57) ABSTRACT

Disclosed herein are a resistance-heated boat and a manufacturing method thereof for use in vacuum vapor deposition of a metal evaporant onto a substrate in a resistance heating manner. The boat comprises a graphite block to be formed into a boat, and a protective barrier formed at the graphite surface for preventing the graphite layer from reacting with the metal evaporant. The protective barrier has an aluminum-rich layer, and a nitrogen containing compound layer. According to the present invention, it is possible to achieve stable and continuous evaporation of metals including aluminum.

### TECHNICAL FIELD

The present invention relates to a resistance-heated boat employed for the deposition of thin films using vacuum vapor deposition, and a manufacturing method thereof. More particularly, the present invention relates to a resistance-heated boat, and a manufacturing method thereof, the resistance-heated boat being manufactured by forming graphite into a boat, and coating it with specific compounds, thereby enabling stable and continuous evaporation of metals, such as aluminum.

### BACKGROUND ART

As well known to those skilled in the art, vacuum vapor deposition is a general technique for coating materials, such as aluminum, silver, gold, copper, and tin on metal, glass, or plastic substrates, and is one of the physical vapor deposition (PVD) techniques using vacuum. In recent years, the PVD techniques have been increasingly applied since they less adversely affect the environment compared to existing wet plating techniques. The PVD techniques include vacuum vapor deposition, sputtering, and ion plating. In the case of the deposition of metals including aluminum, the vacuum vapor deposition and sputtering are mainly employed for general uses, but, when it is especially desired to improve corrosion resistance, adhesion force, and density of the films, the ion plating is employed.

In the production of thin films using the vacuum vapor deposition, three types of heating sources, such as resistance heating source, electron beam heating source, and induction heating source, are generally employed to heat and evaporate the materials. The induction heating source is mainly used in large-scale coating apparatus since it has a tendency of employing complicated peripheral devices due to the use of high frequencies. The electron beam heating source is widely used in big plants as well as in the manufacture of experimental thin films, by virtue of the fact that they can evaporate almost all kinds of materials. The electron beam heating source, however, has a disadvantage of being expensive. The resistance heating source is used in various fields because of their simple installation and inexpensive price features, but it also has a disadvantage in that it can evaporate only a limited range of materials.

Among the above described heating sources, the resistance heating source is manufactured by forming refractory metals or intermetallic compounds into a boat, crucible or filament shape, and is also called evaporation source. Here, the evaporation source is the general term for objects, which serve to melt and evaporate materials received therein as they are heated by directly passing electric current through their bodies. In general, boat-shaped evaporation source is most frequently used, and such an evaporation source is simply called a boat. Hereinafter, the term “boat” designates resistance-heated boat as the evaporation source used in the vacuum vapor deposition system in which the resistance heated boat is adapted as a vaporizing source. The resistance-heated boat is made of refractory metals such as tungsten, molybdenum, and tantalum, or amorphous carbon or graphite, or intermetallic compound such as TiB₂.BN composite, and the like. In practical use, these materials are formed into a filament (or coil), boat or crucible. The use of the resistance-heated boat enables easy production of thin films having a high purity when metals having a low melting point and low reactivity with the boat materials are used.

Aluminum is a metal characterized by its glossy color, high reflectivity of visible and ultraviolet lights, and good corrosion resistance in the atmosphere, and thus is widely used for the production of various thin films such as decorative films for cosmetic cases or accessories, light reflecting coatings for glass or metals, semiconductor conducting films, protective films for magnetic materials or steel plates, metal film formation on the surface of fluorescent coatings for CRT (cathode ray tube), films for condensers, packing materials having improved packing-ability and marketability, and other plastic protective films. According to the latest developments in space exploration and aerospace industry, many researches to improve corrosion resistance and mechanical properties of various materials by coating them with aluminum have been actively undertaken.

Meanwhile, aluminum has a characteristic of high vaporizing temperature in spite of its low melting point, and especially, in case of molten aluminum, it has a high reactivity with other materials. This makes it difficult for the aluminum to be evaporated by using the conventional boat, since aluminum causes damage to the boat as it produces compounds by reacting with refractory metals constituting the boats. Therefore, for the evaporation of the aluminum, filament source made with tungsten wire has been used when single evaporation is adapted for the evaporation system. However, for the long time or continuous evaporation of aluminum, intermetallic compound boats, such as TiB₂.BN boat (so-called BN boat or BN heater), which have an enhanced wetting capability (or so-called spreading capability) as well as a low reactivity with the molten aluminum, have been widely used.

The above mentioned single evaporation method using the tungsten filament has been used since the vacuum vapor deposition techniques were first known, and utilizes an evaporation principle of aluminum wetting on the filament surface, which means that aluminum gets wet onto the surface of the tungsten filament and is evaporated by the heat generated on the filament by electric current. Although this method achieves high evaporation rate, it has a disadvantage of an extremely short life time due to the fact that the aluminum reacts with the surface of the tungsten filaments and in turn the filament is damaged, as it spreads throughout the surface of the tungsten filament.

The BN boat is manufactured by mixing both titanium diboride (TiB₂) powder and boron nitride (BN) powder at an approximate amounts of 50 percent by weight, and then sintering the resulting mixture at high temperature and high pressure. The BN boat may further include an effective amount of other various materials in order to achieve an improvement in capabilities thereof. Among constituents of the BN boat, titanium diboride is used to improve electrical conductivity and wetting capability of the boat, and the boron nitride is used for a support or coupler. Many patents for such BN boats have been granted.

Most of these patents had the goal of enhancing the life time or wetting capability of the BN boat. The BN boat, however, has a problem in that they are very expensive since they are manufactured by sintering relatively expensive raw materials under the high temperature and pressure. Such a BN boat has a further problem in that it is essentially impossible to recycle them, and thus in order to solve this problem, U.S. Pat. No. 4,847,031 discloses a recycling means for the BN boats. The disclosed recycling means of the BN boats, however, are not particularly advantageous from an economic standpoint since it must pass through a process similar to the initial manufacturing process thereof. Furthermore, the conventional BN boat has yet another problem of a splash phenomenon wherein molten aluminum lumps are often ejected from the boat, and adhere to the substrate. Such a splash phenomenon is known to be related to the wetting characteristics of the boat, and efforts to solve the splash phenomenon are ongoing.

Graphite can be classified as a suitable material for the manufacture of the resistance-heated boat since it is inexpensive, and enables the evaporation of certain materials having a low reactivity with the graphite due to its high temperature stability. The resistance-heated boat made of the graphite, however, exhibit several problems in relation to the evaporation of reactive materials such as aluminum since the aluminum produces intermetallic compounds such as Al₄C₃ by reacting with the graphite. Therefore, the graphite has been restrictively used as a crucible for use in induction heating evaporation source, electron beam source liner, and the like. In cases where the graphite is used in the boats for evaporating copper or silver, the evaporants are scattered due to their low wetting properties, thereby causing a deterioration in evaporation efficiency (rate) and consequently a difficulty in use thereof. Further, in cases of the boat for evaporating aluminum or iron having a high reactivity with the graphite, the evaporant attacks the boat and eventually the boat is broken at high temperature.

The inventors of the present invention have applied for a patent titled in “Method of manufacturing boat for use in the evaporation of aluminum” (Korean Patent No. 088573), which is related to the method of experimentally evaporating aluminum, in order to solve the above problems such as the damage to the graphite.

In the above-mentioned patent, although it has no problem in the case of intermittent evaporation for experimental applications, when it is necessary to continuously evaporate materials such as aluminum, there is a problem in that the aluminum as an evaporant flows out of the evaporating surface of the boat and reacts with the graphite surface of the boat in a holder region provided in a vacuum vapor deposition apparatus, thereby causing damage to the boat and causing the evaporant to be deposited on the holder region, and that a great amount of the aluminum is not evaporated, resulting in a serious loss of aluminum.

### DISCLOSURE OF THE INVENTION

Therefore, the present invention has been made in view of the above problems, and it is an object of the present invention to provide a resistance-heated boat, which is made of inexpensive graphite, and enables stable and continuous evaporation of metals, such as aluminum, having a poor wetting capability and a high reactivity with the graphite thereof, and a manufacturing method thereof.

In accordance with one aspect of the present invention, the above and other objects can be accomplished by the provision of a resistance-heated boat for use in vacuum vapor deposition of a metal film onto the substrate by vaporizing the evaporant with a resistance-heated boat, comprising: a graphite block to be formed into a boat; and a protective barrier formed at a surface of the graphite for preventing the graphite layer from reacting with the metal evaporant, wherein the protective barrier includes an aluminum-rich compound layer and a nitrogen containing compound layer.

Preferably, the protective barrier may further include a boron containing compound layer, which is distributed in the form of lump-shaped crystalline deposits.

Preferably, the protective barrier may have a thickness in the range of 20 micrometers to 200 micrometers.

In accordance with another aspect of the present invention, there is provided a method of manufacturing a resistance-heated boat for use in vacuum vapor deposition, comprising the steps of; a) forming a graphite block into a boat having an evaporation cavity formed at a surface thereof for positioning the metal evaporant, such as aluminum; b) coating the surface of the graphite with a nitrogen containing compound; c) producing a protective barrier at the surface of the graphite surface by positioning the aluminum inside the evaporation cavity formed at the center of the graphite boat, and causing a reaction between the aluminum and the nitrogen containing compound through a heat treatment process, the protective barrier serving to prevent the graphite surface from reacting with the molten evaporant.

Preferably, the step b) may include the steps of: b-1) adding catalysts to the nitrogen containing compound, the catalysts serving to increase the rate of the reaction between the aluminum and the nitrogen containing compound; and b-2) coating the nitrogen containing compound together with the catalysts.

Preferably, in the step b), the nitrogen containing compound may be a boron nitride.

Preferably, the catalysts may include at least one selected from among a group consisting of aluminum oxide, titanium, vanadium, iron, and silicone.

Preferably, in the step b), a resultant coating layer may have a thickness in a range of 0.005 g/dm² to 0.4 g/dm².

Preferably, the step b) may be performed in a spraying manner.

Preferably, the step b) may be performed in a painting manner.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a plan view illustrating a resistance-heated boat in accordance with the present invention;

FIG. 1b is a side view illustrating the resistance-heated boat in accordance with the present invention;

FIG. 2 is a perspective view schematically illustrating a boat manufacturing apparatus in accordance with the present invention;

FIG. 3 is a sectional view schematically illustrating a protective barrier of the resistance-heated boat in accordance with the present invention; and

FIG. 4 is an enlarged picture illustrating the protective barrier of the resistance-heated boat in accordance with the present invention.

### BEST MODE FOR CARRYING OUT THE INVENTION

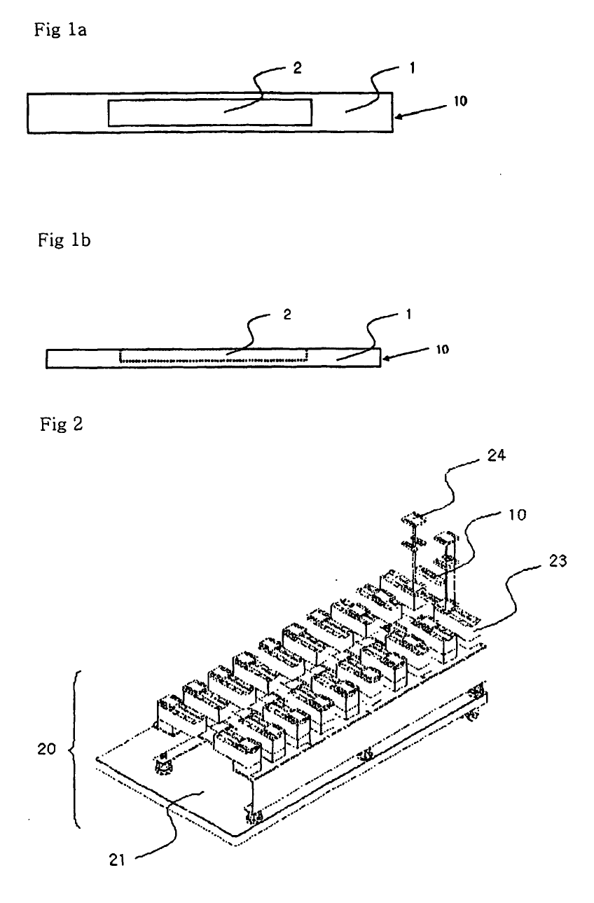

FIGS. 1a and 1b are a plan view and a side view, respectively, illustrating a resistance-heated boat in accordance with the present invention.

As shown in FIGS. 1a and 1b, the boat, designated as reference numeral 10, comprises a body 1, and a cavity 2 formed at the center region of the body 1 as an evaporation region. Inside the evaporation cavity 2 is located a metal evaporant, which is to be deposited on a substrate during the vacuum vapor deposition process. The boat 10, comprising the body 1 and the evaporation cavity 2, is used in the vacuum vapor deposition process in a state wherein it is supported by a boat manufacturing apparatus (referring to FIG. 2).

FIG. 2 schematically illustrates an apparatus for manufacturing the resistance-heated boat in accordance with the present invention.

As shown in FIG. 2, the boat manufacturing apparatus, designated as reference numeral 20, is preferably configured so that a plurality of the boats 10 are mounted thereon. The boat manufacturing apparatus 20 comprises a plurality of boat holders 24 for use in the fixing of the plurality of the boats 10, respectively, a plurality of water-cooled blocks 23 for use in the cooling of the plurality of the boats 10 as well as the supporting of the plurality of the boat holders 24, and a holder support base 21 for supporting the plurality of the water-cooled blocks 23. With the boat manufacturing apparatus 20 configured as stated above, a plurality of resistance-heated boats in accordance with the present invention can be simultaneously manufactured as the plurality of the boats 10, which are formed at the surface thereof with a coating layer, respectively, are mounted on the boat manufacturing apparatus 20 and undergo a heat treatment process.

Now, a manufacturing method of the resistance-heated boat in accordance with the present invention will be explained.

In the manufacture of the resistance-heated boats of the present invention, first, the boat 10, comprising the body 1 and the evaporation cavity 2, is prepared by forming a graphite block into a boat. Then, the boat 10 is coated with a nitrogen containing compound by spraying, and is dried for a predetermined time. In this case, it should be understood that the nitrogen containing compound may be coated onto the boat 10 independently or together with other additives, and the coating thereof may be performed by painting as well as spraying.

Preferably, the resultant coating layer formed at the surface of the graphite layer has a thickness in a range of 0.005 g/dm² and 0.4 g/dm². If the thickness of the coating layer is smaller than 0.005 g/dm², it results in a risk of a failure in the formation of an effective protective barrier during the heat treatment process, as well as a risk of a reaction possibility between evaporant aluminum and the graphite layer of the boat 10. Conversely, if the thickness of the coating layer is greater than 0.4 g/dm², such an excessively thick thickness results in a deterioration in economical efficiency, and an excessively reduced reaction velocity due to poor heat transfer therethrough.

The additives, added together with the nitrogen containing compound, serve as catalysts for increasing the rate of a reaction between the aluminum and the nitrogen containing compound, such as boron nitride, and examples thereof may include aluminum oxide, titanium, vanadium, iron, silicone, and the like. In addition to such a function of facilitating the reaction between the aluminum and the boron nitride during the heat treatment process, the catalysts, added to the nitrogen containing compound, further function to remove any impurities possibly existing in the graphite layer of the boat 10 therefrom.

In succession, the plurality of the boats 10 formed with the coating layer as stated above are mounted on the boat manufacturing apparatus 20 shown in FIG. 2, and then the evaporation cavity 2 of the respective boat 10 is charged with aluminum as an evaporant. As the aluminum reacts with the boron nitride during a heat treatment process, at the surface of the cavity of graphite is formed a protective barrier comprising an aluminum rich layer and a nitrogen containing compound layer. That is, as a heat treatment process is performed after the aluminum is placed at the nitrogen containing compound coating layer, a part of the aluminum produces a stable aluminum nitride by reacting with a nitrogen constituent of the nitrogen containing compound. As a result, the protective barrier is comprised of the aluminum rich layer containing aluminum as its main constituent, and the nitrogen containing compound layer containing aluminum nitride as its main constituent.

Here, the nitrogen containing compound layer produced in the protective barrier contains aluminum nitride as the main constituent as stated above, and is different from the nitrogen containing compound to be added for the coating of the boats 10 in view of their properties. For example, if the boron nitride is used as the nitrogen containing compound to be added in coating, the protective barrier is comprised of the aluminum rich layer, a boron containing compound layer, and the nitrogen containing compound layer containing the aluminum nitride as the main constituent.

As can be seen from the above description, in case of vacuum deposition using the resistance-heated boat in accordance with the present invention, after the metal evaporant such as the aluminum, is located in the evaporation cavity 2 of the boat 10 manufactured as stated above, it is evaporated in a resistance heating manner by passing electric current through the boat 10, and is deposited onto a substrate during a vacuum deposition process.

Now, the resistance-heated boat of the present invention manufactured according to the method as stated above will be explained in detail.

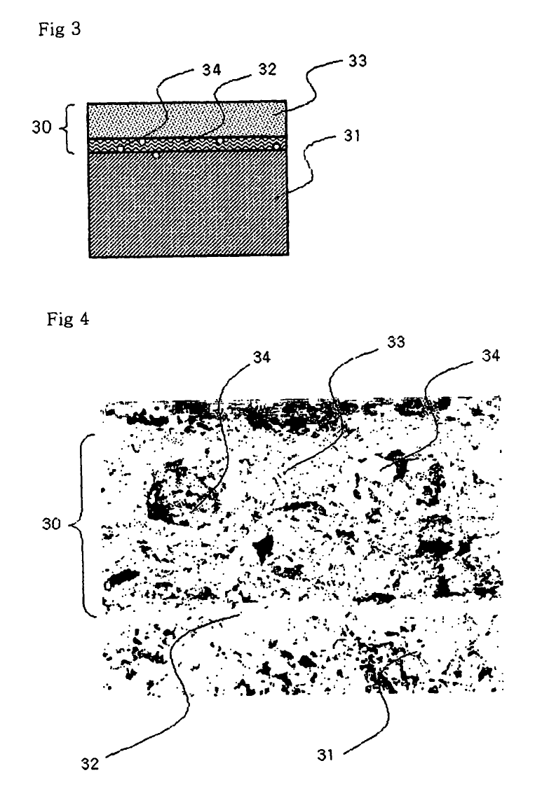

FIG. 3 is a sectional view schematically illustrating the protective barrier of the resistance-heated boat in accordance with the present invention.

As shown in FIG. 3, the resistance-heated boat in accordance with the present invention generally comprises a graphite layer 31, and a protective barrier 30 formed at the surface of the graphite 31 for preventing the graphite layer 31 from reacting with the metal evaporant such as the aluminum. The protective barrier 30 includes an aluminum rich compound layer 32, and a nitrogen containing compound layer 33. In an embodiment shown in FIG. 3, the nitrogen containing compound to be added for the coating of the graphite surface 31 is boron nitride.

That is, in the embodiment shown in FIG. 3, the protective barrier 30 is comprised of the aluminum rich compound layer 32, the nitrogen containing compound layer 33, and a boron containing compound layer 34. More particularly, at the surface of the graphite layer 31 is formed the aluminum leach layer 32, and in turn, at the surface of the aluminum leach layer 32 is formed the nitrogen containing compound layer 33, and the boron containing compound layer 34 is distributed in the aluminum rich compound layer 32 in the form of a plurality of lump shaped crystalline deposits. Here, the boron containing compound layer 34 contains aluminum boride as its main constituent, and the nitrogen containing compound layer 33 is uniformly diffused throughout the protective barrier 30.

In the case of the boron containing compound layer 34, although it exists even in the nitrogen containing compound layer 33 formed at the uppermost region of the protective barrier 30 in an initial stage of the heat treatment process, it gradually descends according to the progress of the heat treatment process, thereby moving down to the aluminum rich compound layer 32 as shown in FIG. 3. In this case, a part of the boron containing compound layer 34 further moves down even to the graphite layer 31. Since the boron containing compound layer 34 is a compound produced only when the nitrogen containing compound to be coated is boron nitride, any other compounds can be produced if another nitrogen containing compounds, aside from the boron nitride, are coated. For example, if the nitrogen containing compound to be coated is titanium nitride, a titanium containing compound will be produced. Although these different compounds such as boron and titanium containing compounds are produced according to the kinds of the nitrogen containing compounds to be coated, in all cases, they essentially must be stable enough so as not to react with the metal evaporant as well as so as not to act as impurities inside the boat.

Preferably, the protective barrier 30 of the resistance-heated boat 10 in accordance with the present invention has a thickness in the range of 20 micrometers to 200 micrometers. If the thickness of the protective barrier 30 is smaller than 20 micrometers, it is not effectively protect the graphite layer 31. Conversely, if the thickness of the protective barrier 30 is greater than 200 micrometers, it results in a deterioration in economic efficiency with relation to the formation of the protective barrier 30, and adversely affects the evaporation of the metal evaporant due to an increase in heat loss.

Hereinafter, the evaporation principle of the metal evaporant using the resistance-heated boat of the present invention, and a reason why the metal evaporant can be evaporated for a long time without reacting with the graphite will be explained under an assumption that the metal evaporant is aluminum.

After an appropriate amount of aluminum is loaded in the evaporation cavity 2 of the boat 10 and the chamber holding the boat is evacuated, and then electric current is applied to the boat 10 so as to gradually heat the boat 10. From a time when the temperature of the boat 10 is higher than the melting point of the aluminum, the aluminum starts to melt, thereby wetting the nitrogen containing compound layer 33 as a protective barrier. In succession, the applied electric power increases so that the temperature of the boat 10 exceeds the vaporizing temperature of the aluminum, resulting in the evaporation of the molten aluminum in the nitrogen containing compound layer 33. In this case, the aluminum can be evaporated at high evaporation efficiency as it flows throughout the evaporation cavity 2. The reason why the aluminum does not react with the graphite layer 31 in spite of being evaporated at the high evaporation efficiency can be explained in view of reaction energy. That is, the aluminum does not react with the graphite layer 31 since the energy required for the aluminum to be absorbed into the nitrogen containing compound layer 33 is lower than the energy required for a reaction between the aluminum and the graphite layer 31. This can be easily understood from the fact that the aluminum rich compound layer 32 containing the aluminum as the main constituent does not generate carbides such as aluminum carbide, even if it exists between the surfaces of the nitrogen containing compound layer 33 and the graphite layer 31.

Now, a first embodiment of the manufacturing method of the resistance-heated boat in accordance with the present invention will be described.

The present embodiment relates to the manufacturing method of the resistance-heated boat for use in the coating of aluminum. Here, the coating of the aluminum is performed by supplying pallets at regular intervals so as to be used in the coating of braun tubes. The manufacturing method utilizes a vacuum heat treatment process.

In the present embodiment, first, a graphite block having a density of 1.8 g/cm³ and a specific resistivity of 1100 micro-ohm centimeters was formed into the body 1 of 0.6 cm wide by 11 cm long by 0.4 cm thick. In this case, the evaporation cavity 2 formed at the body 1 was 0.4 cm wide by 6 cm long by 0.25 cm deep. After that, the boat 10 having the evaporation cavity 2 therein as stated above was coated with the boron nitride to a thickness of 0.15 g/dm² by spraying. In this case, the boron nitride was added with aluminum oxide, titanium, and vanadium. After coating, the boat 10 was dried for a predetermined time.

The above mentioned aluminum oxide, titanium, and vanadium serve as catalysts for increasing the rate of a reaction between aluminum as an evaporant and the boron nitride. Aside from the above-named additives, iron, silicone, and the like may be further added to the boron nitride. The content of these additives was adjusted in an amount of less than 5 percent by weight. Preferably, the thickness of a resultant boron nitride coating layer was in the range of approx. 0.05 g/dm² to 4 g/dm².

In succession, the boat 10, which was formed with the boron nitride coating layer according to the above mentioned process, was mounted to the boat holder 24 of the boat manufacturing apparatus 20 as shown in FIG. 2, and 0.3 g of aluminum wire was inserted into the evaporation cavity 2 of the boat 10. Then, in a state wherein the boat 10 was subject to a vacuum of below 10⁻⁵ Torr by using a vacuum pump (not shown), electric power was applied to a heating power source (not shown), thereby causing a reaction between the aluminum and the boron nitride through a heat treatment process. In this case, the voltage applied to the boat 10 during the heat treatment process was 4.5V, and the ampere thereof was varied from 80 A to 110 A according to reaction time. In the present embodiment, the reaction time was five minutes, and the reaction temperature ranged between 1300° C. and 1500° C. As the above process was repeated one or several times, the protective barrier 30 capable of preventing a reaction between the aluminum and the graphite was achieved. In the manufacture of the resistance-heated boat 10 in accordance with the present invention as stated above, the formation of the protective barrier using the heat treatment process was allowable under either vacuum or inert gas.

FIG. 4 is an enlarged picture illustrating the protective barrier of the resistance-heated boat in accordance with the present invention.

In the above embodiment, the boron containing compound layer 34 contained aluminum boride as a main constituent, and took the form of lump shaped crystalline deposits, and the nitrogen containing compound layer 33 was uniformly diffused throughout the protective barrier 30. Meanwhile, the thickness of the protective barrier 30 obtained according to the above embodiment of the manufacturing method was 100 μm. As a result of analyzing impurities existing in the protective barrier 30 by means of various analytical instruments, it was found that the protective barrier 30, which was obtained through an insufficient reaction between the aluminum and the boron nitride, contained in the surface region thereof certain impurities such as aluminum oxide, titanium, vanadium, and the like used as additives, but the protective barrier 30, which was obtained through a complete reaction under appropriate conditions, had no impurities including metal components or any other impurities. Here, although the additives acted as impurities in case of the insufficient reaction, the additives are required to increase the rate of the reaction between the aluminum and the boron nitride.

An experiment for confirming the life time of the boat 10 manufactured according to the above embodiment was performed by using a vacuum deposition system adopting a pellet supply manner. As a result of the experiment, it was found that the boat 10 could perform vacuum deposition operations more than 400 times. In this case, the weight of a single pallet was 35 mg. Further, from an experiment for examining a reflectivity and constituents of an aluminum coating of 1500 Å obtained by using the boat 10 manufactured according to the above embodiment, it was found that the boat exhibited equal or superior results compared to existing BN boats. In this way, the utility of the resistance-heated boat manufactured according to the method of the present invention was confirmed.

Now, a second embodiment of the manufacturing method of the resistance-heated boat in accordance with the present invention will be described.

The present embodiment embodies the boat 10 for use in the manufacture of aluminum films, which are intended to use for the manufacture of packing materials, webs, and condenser films. In this case, the boat was for use in an aluminum coating apparatus configured to continuously supply aluminum wires, and was manufactured by performing a heat treatment process under the argon gas.

In the present embodiment, first, a graphite block having a density of 1.76 g/cm³ and a specific resistivity of 1200 micro-ohm centimeters was formed into the body 1 having a size of 1.9 cm wide by 15 cm long by 7 cm thick. In this case, the evaporation cavity 2 formed at the body 1 was 1.5 cm wide by 10 cm long by 0.2 cm deep. Then, the boat 10 was coated with the boron nitride to a thickness of 0.1 g/dm² by painting, and then was dried for a predetermined time.

The dried boat 10 was mounted in a vessel, which was mounted with a power source. In succession, after 3 g of aluminum wire were loaded into the boat 10, argon gas was injected into the vessel to remove air existing in the vessel. In this case, by allowing the argon gas to be injected into one side of the vessel as well as to be discharged from the other side of the vessel, an argon gas environment was created inside the vessel. After the vessel was filled with the argon gas, electric power was applied to the power source, thereby causing a reaction between the aluminum and the boron nitride. During this reaction, the electric power was set so that the voltage thereof was 5V, and the ampere thereof was varied in the range of 400 A to 600 A. After completion of the reaction, the heat treatment process of the boat was performed for ten minutes without change of the electric power. Through the manufacturing method as stated above, the resistance-heated boat of the present invention was manufactured.

An experiment for confirming the life expectancy of the boat 10 manufactured according to the above second embodiment of the present invention was performed by using a vacuum deposition system configured to continuously supply the aluminum wire. Here, the diameter of the supplied aluminum wire was 1.6 cm, and the feeding speed of the wire was adjusted to 40 cm per minute. As a result of the experiment, it was found that the boat 10 could be successively evaporated for more than 8 hours without breakage thereof.

Further, through a continuous evaporation experiment using the resistance-heated boat manufactured according to the method of the second embodiment, it was found that the resistance-heated boat in accordance with the present invention does not exhibit a splash phenomenon, which is conventionally noted as a problem of existing BN boats.

### INDUSTRIAL APPLICABILITY

As apparent from the above description, the present invention provides a resistance-heated boat, which enables stable and continuous evaporation of metals such as aluminum, and a manufacturing method thereof. The resistance-heated boat of the present invention can be widely used for the coating of aluminum for CRT tubes, as well as for continuous vacuum deposition methods using roll-to-roll coating systems for the manufacture of packing materials, condensers and conductive packing films, and other electronic components. Especially, since the resistance-heated boat according to the present invention is inexpensive and exhibits improved evaporation performance, compared to existing BN boats, it is possible to achieve an increase in yield and an improvement in quality by virtue of process stability of the boat, and to anticipate advantageous economical effects, such as an improvement in productivity of final products.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A resistance-heated boat for use in vacuum deposition of a metal evaporant to a substrate in a resistance heating manner, comprising:
a graphite block to be formed into a boat; and
a protective barrier formed at a surface of the graphite for preventing the graphite layer from reacting with the metal evaporant,
wherein the protective barrier includes an aluminum-rich compound layer and a nitrogen containing compound layer.

2. The boat as set forth in claim 1, wherein the protective barrier further includes a boron containing compound layer, which is distributed in the form of lump-shaped crystalline deposits.

3. The boat as set forth in claim 1, wherein the protective barrier has a thickness in a range of 20 to 200 micrometers.

4. A method of manufacturing a resistance-heated boat for use in vacuum vapor deposition of a metal evaporant to a substrate in a resistance heating manner, comprising the steps of:
a) forming a graphite block into the form of a boat having an evaporation cavity formed at a surface thereof for positioning the metal evaporant such as aluminum;
b) coating the surface of the graphite layer with a nitrogen containing compound;
c) producing a protective barrier at the surface of the graphite surface by positioning the aluminum inside the evaporation cavity formed at the center of the graphite boat, and causing a reaction between the aluminum and the nitrogen containing compound through a heat treatment process, the protective barrier serving to prevent the graphite surface from reacting with the metal evaporant.

5. The method as set forth in claim 4, wherein the step b) includes the steps of:
b-1) adding catalysts to the nitrogen containing compound, the catalysts serving to increase a rate of the reaction between the aluminum and the nitrogen containing compound; and
b-2) coating the nitrogen containing compound added with the catalysts.

6. The method as set forth in claim 4, wherein, in the step b), the nitrogen containing compound is a boron nitride.

7. The method as set forth in claim 5, wherein the catalysts include at least one selected from among a group consisting of aluminum oxide, titanium, vanadium, iron, and silicone.

8. The method as set forth in claim 4, wherein, in the step b), a resultant coating layer has a thickness in a range of 0.005 g/dm² to 0.4 g/dm².

9. The method as set forth in claim 4, wherein, the step b) is performed in a spraying manner.

10. The method as set forth in claim 4, wherein the step b) is performed in a painting manner.
